(19) United States
(12) Patent Application Publication
(10) Pub. No.: US 2008/0018774 A1
(43) Pub. Date: Jan. 24, 2008

(54) IMAGE CAPTURE DEVICE

(75) Inventors: Hidekazu Nakajima, Osaka (JP); Hiroshi Ueda, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(73) Assignee: MATSUSHITA ELECTRIC INDUSTRIAL CO., LTD., Osaka (JP)

(21) Appl. No.: 11/780,548

(22) Filed: Jul. 20, 2007

(30) Foreign Application Priority Data
Jul. 21, 2006 (JP) 2006-198957

(51) Int. Cl. H04N 5/222

(52) U.S. Cl. 348/333.08; 348/E05.022

(57) ABSTRACT

To provide a single lens reflex digital camera that can find a focus as intended by the shooter even when electronic zoom is ON. An image capture device includes: a movable mirror to be entered into, and removed from, an optical path; an imager for shooting an object image and generating an image signal; a signal processor for zooming in on, or out of, the image based on the signal and generating a processed image signal; a focus sensor for sensing a focusing signal, representing a focusing state of a part of the image, based on the signal; a display device for presenting the image based on the signal; and a controller for controlling the generation of a focus frame to be displayed on the display device. The frame is displayed at a location on the image associated with that part of the image to indicate where the focus sensor should detect the focusing state. The controller changes display of the frame according to whether or not zooming or zoom-out processing is performed by the signal processor on the image and displays the focus frame on the display device.

### BACKGROUND OF THE INVENTION

1. Field of the Invention

The present invention relates to an image capture device and more specifically relates to a digital camera. More particularly, the present invention relates to a digital camera of a single lens reflex type with a shooting mode for sequentially processing image signals supplied from imagers and presenting visible images, represented by the image signals, on a display one after another.

2. Description of the Related Art

Recently, a number of single lens reflex type digital cameras, including imagers such as CCD (charge coupled device) image sensors or CMOS (complementary metal-oxide-semiconductor) image sensors, have been developed and are already on public sale.

A single lens reflex type digital camera has a movable mirror (which is called a “quick return mirror”) for changing the locations of a produced optical image between first and second locations that are different from each other. In capturing an image, such a digital camera produces an optical image at the first location and the imagers receive that image, convert it into an electrical image signal and then output the signal. On the other hand, in determining the composition before capturing the image, the digital camera produces an optical image at the second location and presents it on the focusing screen of a viewfinder. That image is then guided to the shooter's eyes through an observation imaging lens system.

Just like compact digital cameras, single lens reflex type digital cameras equipped with various functions have been proposed. For example, Japanese Patent Application Laid-Open Publication No. 2004-72206 proposes an electronic camera device with an optical zoom function and an electronic zoom function. The optical zoom function is the function of zooming in on, or out of, the imaged object by utilizing the variable power function of the imaging lens system. On the other hand, the electronic zoom function is the function of zooming in on, out of, the imaged object by cutting out and recording a portion of the image signals supplied from the imagers. The device disclosed in the publication cited above can broaden the apparent depth of focus variation range by combining these two types of zoom functions.

Also, various other functions to be carried out during a focus finding operation (i.e., a so-called “autofocusing operation”) have been proposed. For example, the electronic camera device described above senses the output image signals of the imagers with an auto-focus (AF) sensor. Then, the device usually presents an AF frame both on an optical viewfinder and on the display monitor to allow the shooter to see easily what object on the shooting screen is now in focus. This AF frame is superimposed on the image of the object at a location corresponding to the position of the AF sensor. The shooter sets the AF frame on the object to be focused that is now presented on either the optical viewfinder or on the display monitor. Then, the AF sensor senses a signal representing that location, thereby allowing the shooter to take a photo with the focus set on his or her desired spot.

The AF sensor is usually arranged so as to detect an optical signal that has been incident on a predetermined location on the imagers. More specifically, the AF sensor senses a variation in high frequency components at that location and feeds back a focusing signal to an autofocusing control mechanism.

In a situation where the lens has a zoom function, when the electronic camera device either records an image that has been captured in the entire effective pixel area on the imagers or presents it on the monitor, that image that has been captured in the entire effective pixel area on the imagers is presented on the optical viewfinder and on the display monitor even if the zoom function is activated. The image, however, is either zoomed in on or zoomed out of according to the selected zoom power. That is why there should be no deviation between the display location of the AF frame and the physical position of its associated AF sensor.

When the electronic camera device either records an image that has been captured in just a part of the effective pixel area on the imagers or presents it on the monitor, there should be some deviation between the display location of the AF frame and the physical position of its associated AF sensor. This is because even though the image that has been captured in just the part of the area has been zoomed in on to the same size as the image that has been captured in the entire effective pixel area and presented on the optical viewfinder and the display monitor, no attention has been paid to the change of sizes of the AF frame displayed. That is why it is difficult for the shooter to determine whether or not his or her desired object is exactly in focus. It should be noted that the mode of operation of recording an image that has been captured in just a part of the imaging area of the imagers corresponds to an electronic zoom ON mode or a mode of shooting with a modified number of recording pixels.

### SUMMARY OF THE INVENTION

An object of the present invention is to provide a digital camera of a single lens reflex type that can perform a focus finding operation just as intended by the shooter even when the electronic zoom function is ON or when the number of recording pixels is changed.

An image capture device according to the present invention is designed to be connected to an imaging lens device such that the imaging lens device is attachable to, and removable from, the image capture device. The imaging lens device includes an imaging lens system that produces an image of an object. The image capture device includes: a movable mirror, which is entered into, and removed from, an optical path, thereby changing positions where the object image is produced between first and second positions; an imager, which is arranged at the first position to shoot the object image and generate an image signal; a signal processor for performing zoom-in or zoom-out processing on the image in accordance with the image signal and thereby generating a processed image signal; a focus sensor for sensing a focusing signal, representing a focusing state of a part of the object image, based on the object image being produced at the second position; a display device for presenting the image based on the image signal; and a controller for controlling the generation of a focus frame to be further displayed on the display device. The focus frame is displayed at a location on the image that is associated with that part of the object image to indicate a position where the focus sensor is supposed to detect the focusing state. And the controller changes the display modes of the focus frame according to a parameter of the zoom-in or zoom-out processing performed by the signal processor on the image and displays the focus frame on the display device.

The controller may change the sizes of the focus frame according to the zoom-in or zoom-out power of the image performed by the signal processor and may display the focus frame on the display device.

There may be a number of focus frames. In that case, the controller may change distances between the focus frames according to the zoom-in or zoom-out power of the image performed by the signal processor and may display the focus frames on the display device.

The controller may include a memory for storing data items representing a plurality of display modes of the focus frame that are associated with the zoom-in and zoom-out powers of the image to be performed by the signal( ) processor. According to the zoom-in or zoom-out power of the image performed by the signal processor, the controller may make reference to the memory, read one of the data items representing the display modes, change the sizes of the focus frame in accordance with the read data, and then present the frame on the display device.

The memory may store data items representing a plurality of display modes, in which the focus frame has mutually different display locations and magnifications, in association with the zoom-in and zoom-out powers of the image to be performed by the signal processor.

The present invention provides a digital camera of a single lens reflex type that can perform a focus finding operation just as intended by the shooter even when the electronic zoom function is ON or when the number of recording pixels is changed.

### BRIEF DESCRIPTION OF THE DRAWINGS

FIG. 1 shows the arrangement of a digital camera according to a preferred embodiment of the present invention.

FIG. 2 shows an optical path in the camera body 1 in the standard shooting mode.

FIG. 3 shows an optical path in the camera body 1 in the live view mode.

FIG. 4 is a top view of the camera body 1, to which the imaging lens device 2 has been attached, according to this preferred embodiment.

FIG. 5 is a rear view of the camera body 1 of this preferred embodiment.

FIGS. 6(a) and 6(b) show exemplary menu images presented on the display monitor 16 when the digital zoom mode and the EX optical zoom mode are both turned ON and when the digital zoom mode and the EX optical zoom mode are both turned OFF, respectively.

Portions (a) through (c) of FIG. 7 show how image processing is done in the EX optical zoom mode.

Portions (a) through (c) of FIG. 8 schematically show the principle of operation in a situation where the EX optical zoom mode and the zoom function of the lens are used in combination.

Portions (a) through (c) of FIG. 9 show how image processing is carried out in the digital zoom mode.

Portions (a) through (c) of FIG. 10 schematically show the principle of operation in a situation where the digital zoom mode and the zoom function of the lens are used in combination.

FIG. 11 shows exemplary AF frames A and B displayed on the display monitor 16.

FIG. 12 shows an example in which AF frames 122 to 124 are displayed and superimposed on the images of objects.

FIG. 13 shows a relation between the electronic zoom frame 121 and the object images.

FIG. 14 shows the AF frames 130 to 132 that are indicated by the dashed lines in the example shown in FIG. 13.

FIG. 15 is a flowchart showing a first exemplary procedure of AF frame display processing to be carried out by the digital camera.

FIG. 16 is a flowchart showing a second exemplary procedure of AF frame display processing to be carried out by the digital camera.

FIG. 17 is a block diagram showing a control system for the camera body 1 of this preferred embodiment.

FIG. 18 is a block diagram showing a control system for the imaging lens device 2 according to this preferred embodiment.

### DETAILED DESCRIPTION OF PREFERRED EMBODIMENTS

Hereinafter, preferred embodiments of a digital camera according to the present invention will be described with reference to the accompanying drawings.

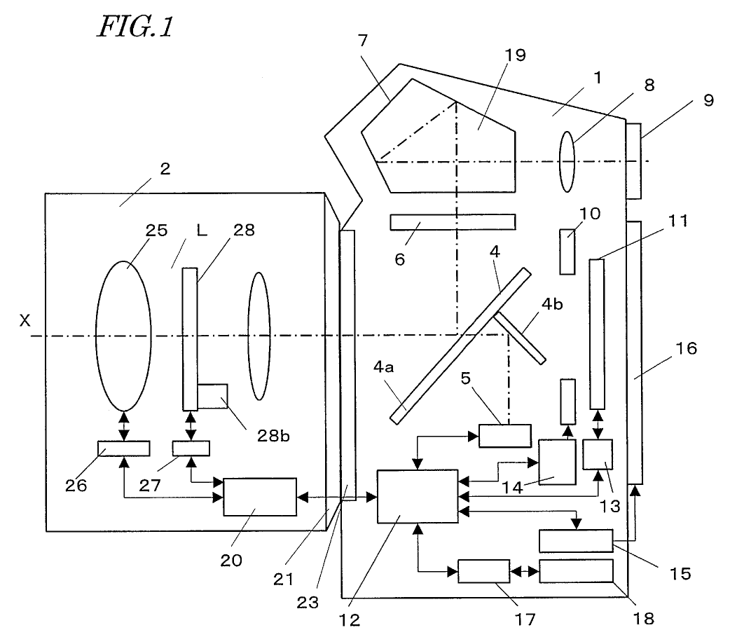

FIG. 1 shows the arrangement of a digital camera according to a preferred embodiment of the present invention. The digital camera is a single lens reflex camera and includes a camera body 1 and an imaging lens device 2. The imaging lens device 2 has a lens mount 21 and is attachable to, and removable from, a body mount 23, which is arranged on the front side of the digital camera 1.

The digital camera 1 includes various optical and electrical elements. Hereinafter, those elements of the digital camera 1, as well as how the digital camera 1 performs a shooting operation, will be described.

The object light that has passed through the imaging lens device 2 reaches a quick return mirror 4, which is arranged so as to be readily entered into, or removed from, the optical path. The object light is split by the main mirror 4a of the quick return mirror 4 into two light beams. The reflected one of the two light beams is guided to a viewfinder optical system 19. Meanwhile, the other transmitted light beam is reflected by a sub-mirror 4b, which is arranged behind the quick return mirror 4, and then is used as an AF light beam by a focus finding unit 5, which adopts a phase difference detecting technique.

The light beam that has been reflected from the main mirror 4a produces an image on a viewfinder screen 6. The object image that has been produced on the viewfinder screen 6 can be monitored through a viewfinder ocular window 9 by way of a pentaprism 7 and an eyepiece 8. It should be noted that the viewfinder screen 6 is arranged at a position where the optical image is produced in the imaging lens system.

The camera body 1 has two shooting modes. One of the two is a standard shooting mode in which the shooter or something takes a shot while monitoring the object through the viewfinder ocular window 9. This mode corresponds to a standard shooting mode for conventional single lens reflex cameras.

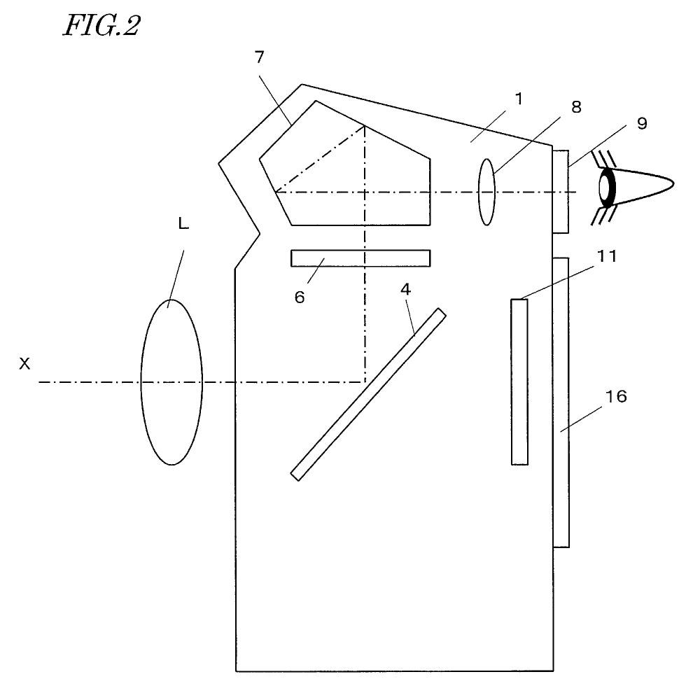

FIG. 2 shows an optical path in the camera body 1 in the standard shooting mode. In the standard shooting mode, the quick return mirror 4 is arranged at a predetermined position on the optical path X, and therefore, the shooter or something can monitor the object image through the viewfinder ocular window 9. In taking a shot actually, the quick return mirror 4 is retracted out of the optical path X and a shutter unit 10 is opened, thereby producing an image of the object on the imaging plane of imagers 11. It should be noted that the imagers 11 are arranged at a position where an optical image is produced in the imaging lens system L.

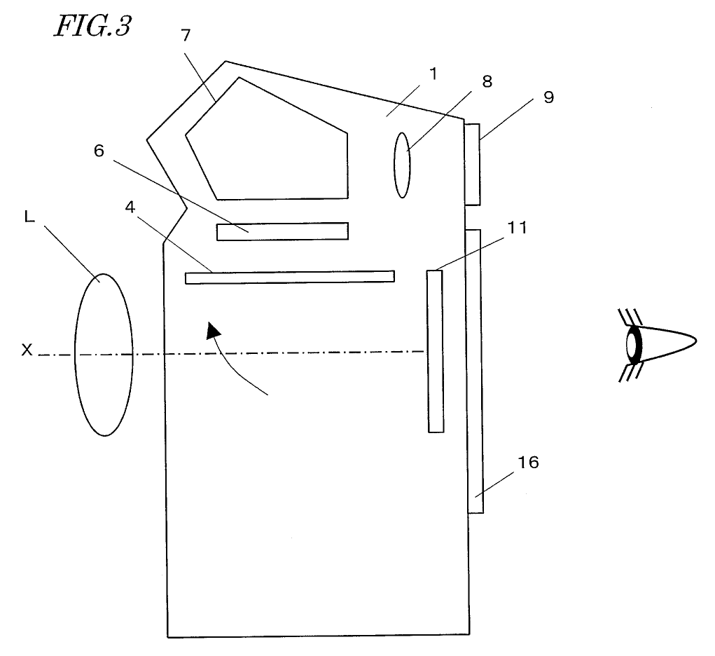

The other shooting mode is a shooting mode in which image signals supplied from the imagers are sequentially processed and visible images represented by the image signals are presented on a display device one after another (which will be referred to herein as a “live view mode”). FIG. 3 shows an optical path in the camera body 1 in the live view mode. In the live view mode, the quick return mirror 4 is fully removed from the optical path X. That is why the object image produced by the imagers 11 (i.e., a so-called “through image”) is presented on a display monitor 16 such as an LCD monitor.

Look at FIG. 1 again. In the camera body 1, there is a body microcomputer 12 for controlling various types of sequences. An imager controller 13 controls the drive operation on the imagers 11. A shutter controller 14 controls the drive operation on the shutter unit 10. An image display controller 15 performs a control operation such that image signals are read from the imagers 11 and subjected to predetermined image processing, and then the captured image is presented on the display monitor 16. An image recording controller 17 gets captured image data read from, and written on, a storage medium such as an SD memory card™ (not shown) by an image read/write section 18. In the following description, writing captured image data will be referred to herein as “recording an image” for convenience sake.

The attachable and removable imaging lens device 2 includes an imaging lens system L for producing an image of the object on the imagers 11 in the camera body 1. A lens microcomputer 20 is also provided to control a number of types of sequences to be performed by the imaging lens device 2 and to store various sorts of lens information. Further provided in the imaging lens device 2 is a focus controller 26 for controlling the drive operation on a group of focus lenses 25. A diaphragm controller 27 is further provided to control a diaphragm unit 28.

Also, the camera body 1 and the imaging lens device 2 exchange various control signals by way of the electronic intercept 22 (not shown) of the lens mount 21 of the imaging lens device 2 and the electronic intercept 24 (not shown) of the body mount 23 of the camera body 1.

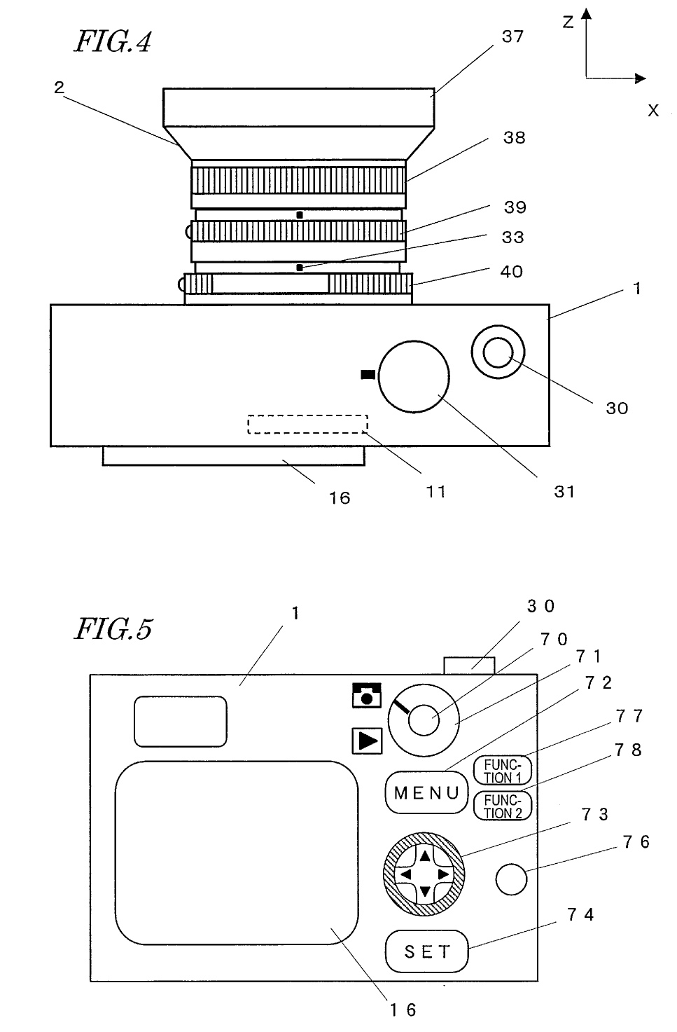

FIG. 4 is a top view of the camera body 1, to which the imaging lens device 2 has been attached, according to this preferred embodiment.

The camera body 1 is a housing to be held by the shooter, for example, who is taking a shot of the object. This camera body 1 includes a shutter button 30 and a shutter speed setting dial 31, which are arranged on the right-hand side on the top of the camera body 1.

The shutter speed setting dial 31 is an operation member that allows the user to set a shutter speed by turning the dial. Also, the shutter speed setting dial 31 has an AUTO position at which the shutter speed is set automatically.

The camera body 1 further includes a display monitor 16, which is arranged so as to face the user of the camera body 1, for example. The function of the display monitor 16 will be described later.

The imaging lens device 2 includes a filter mount 37, which is located closest to the object. The imaging lens device 2 further includes a zoom ring 38, a focus ring 39, and a diaphragm ring 40, which are stacked in this order in the negative z-axis direction from the filter mount 37 toward the camera body 1. Each of the zoom ring 38, the focus ring 39 and the diaphragm ring 40 is a cylindrical rotational operation member and is arranged rotatably on the outer periphery of the imaging lens device 2.

FIG. 5 is a rear view of the camera body 1 of this preferred embodiment. The camera body 1 includes a power button 70, a shooting/playback mode switching lever 71, a MENU button 72, cross operation control keys 73, a SET button 74, a zooming mode button 76, a Function #1 button 77 and a Function #2 button 78.

The power button 70 is an operation member for turning ON and OFF the power of the camera body 1. The shooting/playback mode switching lever 71 is an operation member that allows the user to switch the shooting mode into the playback mode, or vice versa, by turning the dial. As used herein, the shooting mode is a mode that is set for the camera body 1 to newly capture an image of the object and generate an image signal. On the other hand, the playback mode is a mode that is set for the camera body 1 to reproduce the image signal that has already been generated and stored into a visible image on the monitor.

The MENU button 72 is an operation member for presenting various operation menus on the display monitor 16. The cross operation control keys 73 have up, down, right and left keys and are used as an operation member for letting the user select one of displayed items for the various operation menus. The SET button 74 is an operation member that allows the user to enter the displayed and selected item on the various operation menus. The zooming mode button 76 is a button that switches the modes of operation of the camera into the zooming mode to be described later when pressed down. The user may assign his or her frequently used shooting/playback menus to the Function #1 and Function #2 buttons 77 and 78.

The digital camera of this preferred embodiment has an electronic zoom function that zooms in on, or zooms out of, the object image through image processing. The electronic zoom functions can be classified into two shooting modes, namely, EX optical zoom mode and digital zoom mode, according to the type of the image processing to be carried out. Specifically, in the EX optical zoom mode, the number of pixels of the image to be recorded is kept constant irrespective of the zoom power selected. In the digital zoom mode, on the other hand, the greater the zoom power, the smaller the number of pixels of the image cut out and the less fine the image recorded or presented.

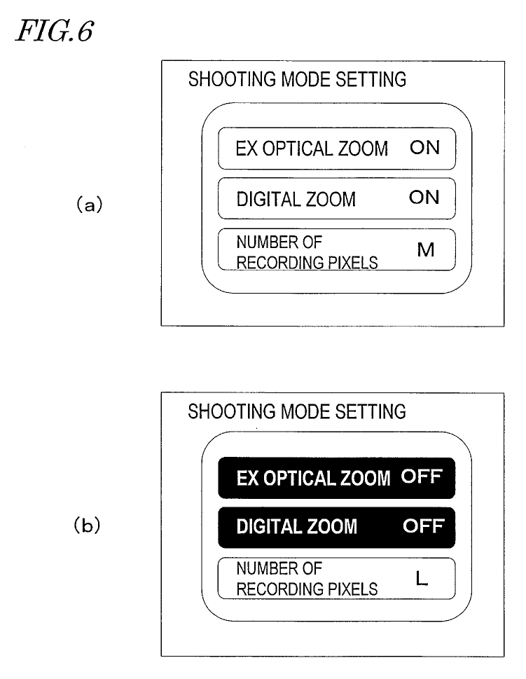

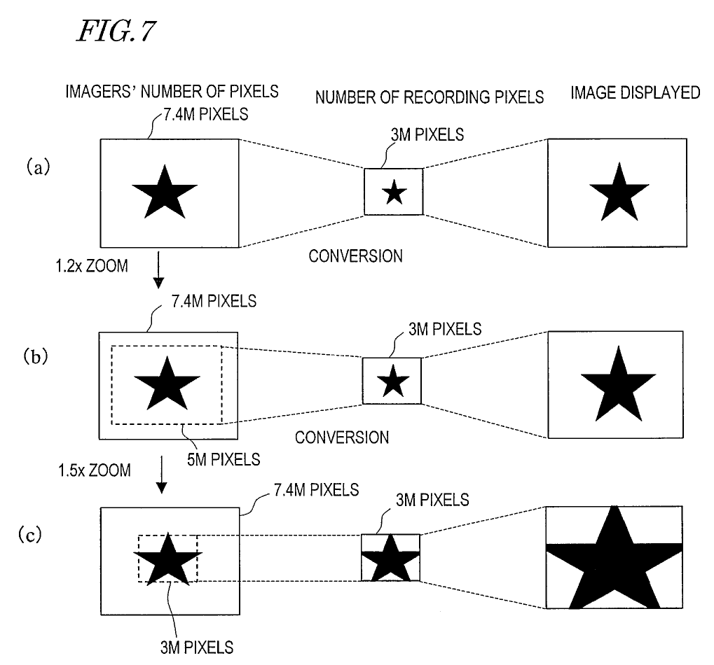

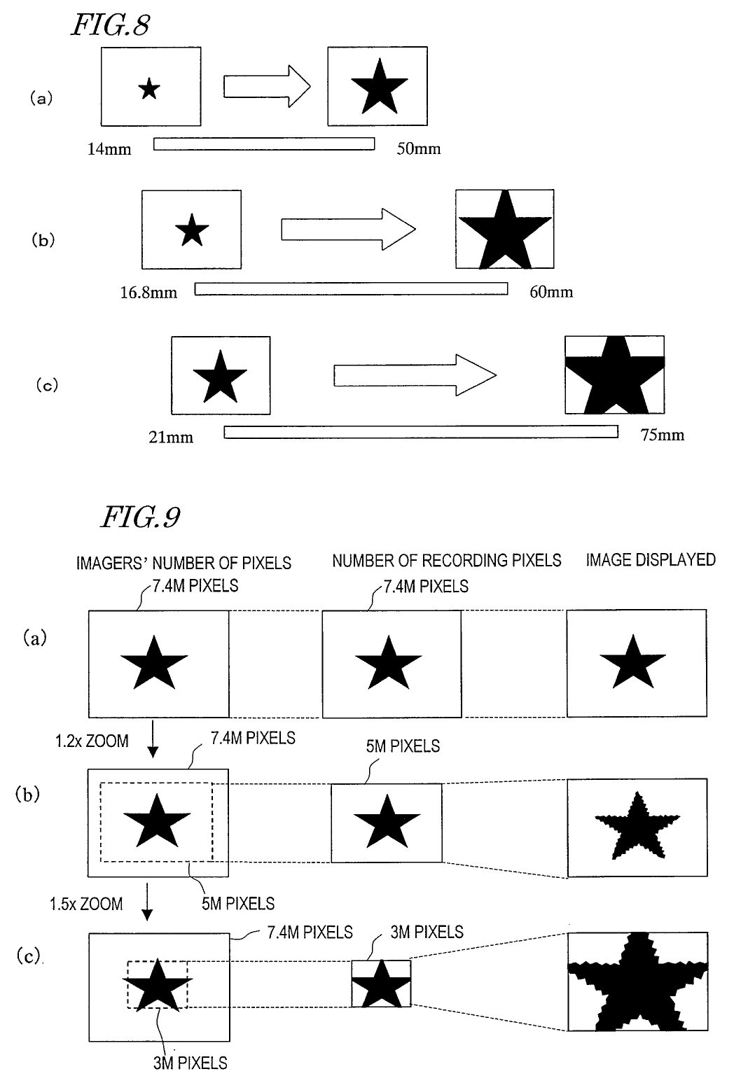

FIGS. 6(a) and 6(b) show exemplary menu images presented on the display monitor 16 when the digital zoom mode and the EX optical zoom mode are both turned ON and when the digital zoom mode and the EX optical zoom mode are both turned OFF, respectively.

Specifically, FIG. 6(a) shows a situation where the live view mode has been selected as the shooting mode. In that case, both the EX optical zoom and the digital zoom are enabled. In this example, any of these options may be picked up with the cross operation control keys 73 and entered by pressing down the SET button 74.

On the other hand, FIG. 6(b) shows a situation where the standard shooting mode has been selected as the shooting mode. In that case, neither the EX optical zoom nor the digital zoom is enabled. In this example, even if the user tries to pick up any of these options with the cross operation control keys 73, none of these options is selectable and setting in those modes is not accepted. By prohibiting the use of the electronic zoom in the standard shooting mode in this manner, even when the shooter is using the optical viewfinder, he or she can determine the composition easily. That is to say, a user-friendly digital camera is provided.

Even in a situation where the live view mode has been selected as the shooting mode, if the number of recording pixels is L (the largest), settings in none of these electronic zoom modes are accepted. That is to say, to make settings for an electronic zoom mode, either S (the smallest) or M (medium) should be selected as the number of recording pixels. By making such a selection, the settings for the electronic zoom mode are accepted.

Hereinafter, the EX optical zoom mode and the digital zoom mode will be described in detail with reference to FIGS. 7 through 10.

Portions (a) through (c) of FIG. 7 show how image processing is done in the EX optical zoom mode. Suppose the imagers have a maximum resolution of 7.4 million recording pixels and the number of pixels of any image recorded in the EX optical zoom mode is always fixed at 3 million, for example.

Specifically, portion (a) of FIG. 7 shows image processing to be carried out in a situation where the user has not selected any electronic zoom mode (i.e., the zoom power is specified as 1.0×). In that case, image data is generated by using all 7.4 million pixels of the imagers fully. Thereafter, the image of 7.4 million pixels is downsized as a whole, converted into image data of 3 million pixels and then recorded. As for the image presented on the display monitor 16, the image data of 7.4 million pixels is cut down as a whole to a size of 6.4 million pixels.

Portion (b) of FIG. 7 shows image processing to be carried out in a situation where the user has set a zoom power of 1.2×. In that case, the inner 5 million pixel portion of the image is cut out from the overall 7.4 million pixels of the imagers. The image that has been cut out in this manner is downsized, converted into image data of 3 million pixels and then recorded. As for the image presented on the display monitor 16, the image of 3 million pixels to be recorded is downsized and presented there.

Comparing the images shown in portions (a) and (b) of FIG. 7 and presented on the display monitor 16 to each other, it can be seen that the image shown in portion (b) of FIG. 7 has a narrower angle of view than that shown in portion (a) of FIG. 7. That is why if these images are presented on the display monitor 16 of the same size, the image shown in portion (b) of FIG. 7 is displayed as an enlarged version of the image shown in portion (a) of FIG. 7.

Portion (c) of FIG. 7 shows image processing to be carried out in a situation where the user has set a zoom power of 1.5×. In that case, the inner 3 million pixel portion of the image is cut out from the overall 7.4 million pixels of the imagers. The image that has been cut out in this manner has the same number of pixels as that of pixels to be recorded, and therefore, is recorded as it is. As for the image presented on the display monitor 16, the image of 3 million pixels to be recorded is downsized and presented there. The image presented in this case is a further enlarged version of the image presented on the display monitor 16 in the example shown in portion (b) of FIG. 7.

It should be noted that these zoom powers are just examples. The same statement will apply to the rest of the description, too.

Portions (a) through (c) of FIG. 8 schematically show the principle of operation in a situation where the EX optical zoom mode and the zoom function of the lens are used in combination. As in the example just described, the imagers are supposed to have a maximum resolution of 7.4 million recording pixels. The imaging lens system is supposed to have a focal length of 14 mm to 50 mm.

Portion (a) of FIG. 8 shows a situation where no electronic zoom mode has been selected. In that case, the captured image data is subjected to a type of image processing such as interpolation processing for reducing the number of pixels. As a result, at any optical zoom power (i.e., at any focal length of 14 mm to 50 mm), the number of pixels of the image data becomes equal to a predetermined number of pixels that is smaller than the maximum number of recording pixels. For example, the image data of 7.4 million pixels is converted into image data with a resolution of approximately 3 million pixels.

Portion (b) of FIG. 8 shows a situation where a zoom power of 1.2× has been set and an electronic zoom mode that would achieve a resolution of approximately 5 million pixels has been selected. In that case, a center portion with 5 million pixels is cut out from the overall 7.4 million pixel area on the imagers and then converted into image data with a resolution of approximately 3 million pixels. That is why supposing this optical zoom has been done using the same imaging lens system, the minimum and maximum focal lengths increase approximately 1.2 times each and the angles of view corresponding to focal lengths of 16.8 mm to 60 mm are defined. In other words, if the optical zoom has been done using the same imaging lens system, the variation in the angle of view of the optical zoom can be narrowed without decreasing the number of recording pixels (i.e., maintaining the same number of recording pixels at three million).

Portion (c) of FIG. 8 shows a situation where a zoom power of 1.5× has been set and an electronic zoom mode that would achieve a resolution of approximately 3 million pixels has been selected. In that case, a shooting operation is performed with a center portion with 3 million pixels cut out from the overall 7.4 million pixel area on the imagers. That is why supposing this optical zoom has been done using the same imaging lens system, the minimum and maximum focal lengths increase approximately 1.5 times each and the angles of view corresponding to focal lengths of 21 mm to 75 mm are defined. That is to say, if the optical zoom has been done using the same imaging lens system, the variation in the angle of view of the optical zoom can also be narrowed without decreasing the number of recording pixels.

Portions (a) through (c) of FIG. 9 show how image processing is carried out in the digital zoom mode. The imagers are also supposed to have a maximum resolution of 7.4 million recording pixels.

Specifically, portion (a) of FIG. 9 shows image processing to be carried out in a situation where the user has not selected any electronic zoom mode (i.e., the zoom power is specified as 1.0×). In that case, the same processing as the image processing in the EX optical zoom mode shown in portion (a) of FIG. 7 is carried out. That is to say, image data is generated by using all 7.4 million pixels of the imagers fully. Thereafter, the image of 7.4 million pixels is downsized as a whole, converted into image data of 3 million pixels and then recorded. As for the image presented on the display monitor 16, the image data of 7.4 million pixels is cut down as a whole to a size of 6.4 million pixels, for example.

Portion (b) of FIG. 9 shows image processing to be carried out in a situation where the user has set a zoom power of 1.2×. In that case, the inner 5 million pixel portion of the image is cut out from the overall 7.4 million pixels of the imagers. The image that has been cut out in this manner is recorded as it is. As for the image presented on the display monitor 16, the image of 5 million pixels that have been cut out is downsized as a whole and presented there.

Comparing the images shown in portions (a) and (b) of FIG. 9 and presented on the display monitor 16 to each other, it can be seen that the image shown in portion (b) of FIG. 9 has a narrower angle of view than that shown in portion (a) of FIG. 9. That is why if these images are presented on the display monitor 16 of the same size, the image shown in portion (b) of FIG. 9 is displayed as an enlarged version of the image shown in portion (a) of FIG. 9.

As for the qualities of the images presented on the display monitor 16, the image shown in portion (b) of FIG. 9 is less fine than that shown in portion (a) of FIG. 9. This is because the image presented on the display monitor 16 has been generated based on the image with a resolution of 7.4 million pixels in portion (a) of FIG. 9 but has been generated based on the image with a resolution of 5 million pixels in portion (b) of FIG. 9.

Portion (c) of FIG. 9 shows image processing to be carried out in a situation where the user has set a zoom power of 1.5×. In that case, the inner 3 million pixel portion of the image is cut out from the overall 7.4 million pixels of the imagers. The image that has been cut out in this manner is recorded as it is. As for the image presented on the display monitor 16, the image of 3 million pixels that have been cut out is downsized as a whole and presented there. The image presented in this case is a further enlarged version of the image presented on the display monitor 16 in the example shown in portion (b) of FIG. 7. As for the qualities of the images presented on the display monitor 16, the image shown in portion (c) of FIG. 9 is less fine than that shown in portion (b) of FIG. 9 for the same reason as that mentioned above.

Portions (a) through (c) of FIG. 10 schematically show the principle of operation in a situation where the digital zoom mode and the zoom function of the lens are used in combination. As in the example just described, the imagers are supposed to have a maximum resolution of 7.4 million recording pixels. The imaging lens system is supposed to have a focal length of 14 mm to 50 mm.

Portion (a) of FIG. 10 shows a situation where no digital zoom mode has been selected. In that case, the angle of view changes within a range corresponding to focal lengths of 14 mm through 50 mm.

Portion (b) of FIG. 10 shows a situation where a 2× digital zoom mode has been selected. In that case, a shooting operation is carried out with a center portion, defined by the zoom power of 2×, cut out. That is why supposing this optical zoom has been done using the same imaging lens system, the minimum and maximum focal lengths are approximately doubled and the angles of view corresponding to focal lengths of 28 mm to 100 mm are defined.

Portion (c) of FIG. 10 shows a situation where a 4× digital zoom mode has been selected. In that case, a shooting operation is carried out with a center portion, defined by the zoom power of 4×, cut out. That is why supposing this optical zoom has been done using the same imaging lens system, the minimum and maximum focal lengths are increased approximately fourfold and the angles of view corresponding to focal lengths of 56 mm to 200 mm are defined.

As can be seen easily from the foregoing description, according to the digital zoom mode, the angle of view can be changed significantly.

Optionally, the EX optical zoom mode and the digital zoom mode described above may be used in combination. Then, the angle of view can be changed even more significantly. For example, if an EX optical zoom mode that would achieve a resolution of approximately 3 million pixels and a 4× digital zoom mode are used in combination and if the imaging lens system has focal lengths of 14 mm through 50 mm, then the angle of view can be changed within a range corresponding to focal lengths of 84 mm through 300 mm.

Next, it will be described with reference to FIGS. 11 through 14 exactly what images will be presented on the display monitor 16 in the EX optical zoom mode and in the digital zoom mode.

On the display monitor 16, AF frames are drawn and superimposed on the object image yet to be taken a shot of. FIG. 11 shows exemplary AF frames A and B displayed on the display monitor 16.

At the positions associated with the AF frames A displayed, arranged are AF sensors for sensing variations in the horizontal RF components of the image signals supplied from the imagers at those positions. On the other hand, at the positions associated with the AF frames B, arranged are AF sensors for sensing variations in the vertical RF components of the image signals supplied from the imagers at those positions.

If no electronic zoom has been selected (i.e., if a zoom power of 1.0× is specified), the location of each AF frame agrees with that of its associated AF sensor over the entire zoom area and the AF operation is performed accurately. It should be noted that the “electronic zoom” could means one or both of the EX optical zoom mode and the digital zoom mode. The same statement will apply to the rest of the description, too.

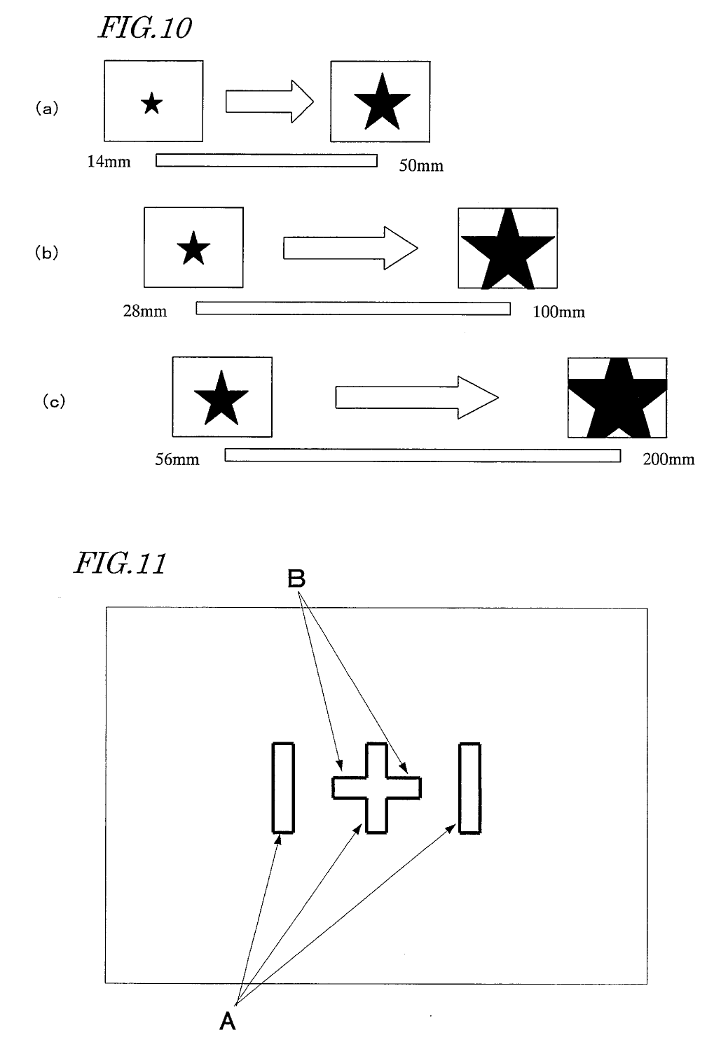

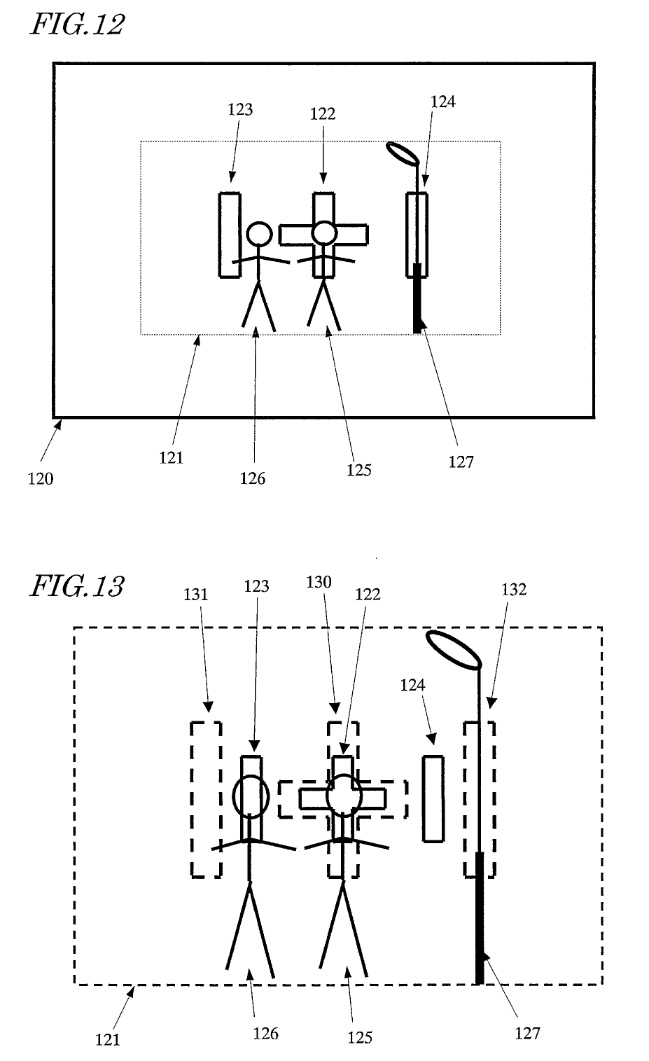

FIG. 12 shows an example in which AF frames 122 to 124 are displayed and superimposed on the images of objects. In this example, a composition including a telegraph pole 127 in front of two persons 125 and 126 is supposed to be adopted.

First, if the user has not selected any electronic zoom mode, a normal shooting frame 120 is displayed. Next, when the user activates an electronic zoom, the shooting mode changes into a mode that uses only some of the imagers and an electronic zoom frame 121 is displayed over the entire display monitor.

FIG. 13 shows a relation between the electronic zoom frame 121 and the object images, which are either zoomed in on, or zoomed out of, according to the electronic zoom power specified. Meanwhile, FIG. 13 also shows an example in which the AF frames 122 to 124 indicated by the solid lines are still displayed at the same locations as those shown in FIG. 12. These AF frames 122 through 124 are presented by the OSD (on screen display) technique so as to be superimposed on the images of the persons A and B.

However, considering that the objects images have been zoomed in on by the electronic zoom, the AF sensors should be actually located as indicated by the dashed lines 130 to 132 and detecting the image signals supplied from the imagers that are present at those locations. That is why if the AF frames 122 to 124 were displayed, the user would misunderstand that the persons A and B are now in focus. Actually, the camera operates so as to find a focus on the person A and on the telegraph pole but no focusing signal is detected as for the person B. Furthermore, while a camera is performing a focus finding operation, the operation is normally controlled such that a focus is found on the closest one of the objects preferentially. In this example, the focus is found only on the telegraph pole, not on the persons A and B. Consequently, the shooter's intended focus finding operation is not guaranteed.

That is why to find a focus just as intended even while the electronic zoom is activated, the respective AF frames should be displayed on the display monitor so as to reflect the electronic zoom power. More specifically, the display locations (or the space between the AF frames) and sizes of the respective AF frames should be changed similarly according to the electronic zoom power.

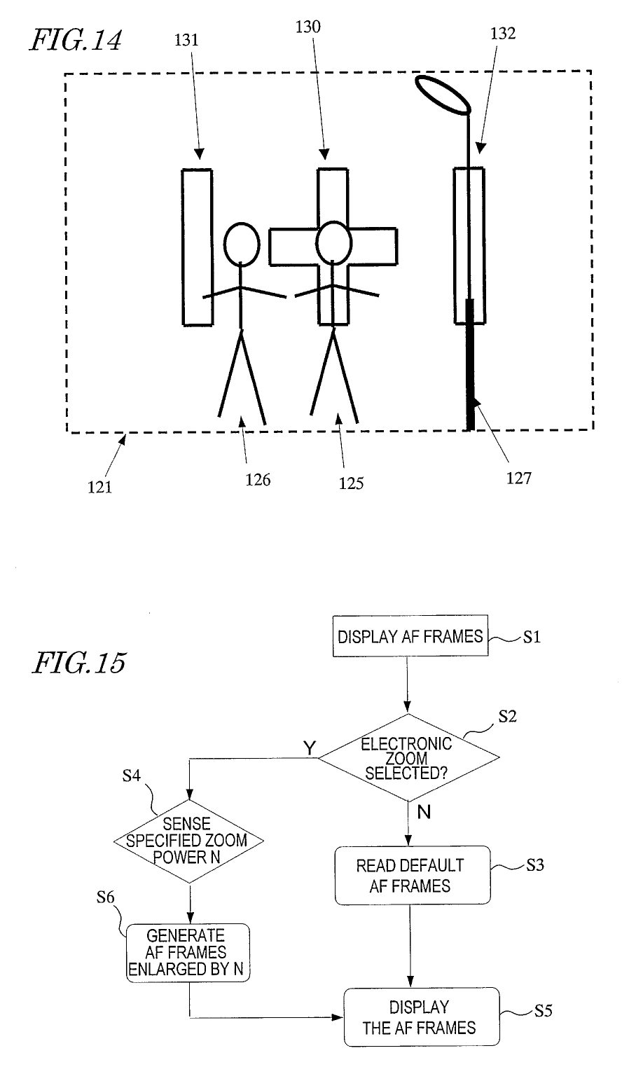

FIG. 14 shows the AF frames 130 to 132 that are indicated by the dashed lines in the example shown in FIG. 13. In FIG. 14, the display locations and sizes of the respective AF frames have been changed according to the electronic zoom power, and therefore, the user can see the positions of the AF sensors properly by reference to the AF frames 130 to 132. As a result, a focus can now be found on any object the user sets his or her heart on.

It should be noted that frame data processing for displaying those AF frames 130 to 132 on the display monitor could be carried out by the body microcomputer 12, for example. The body microcomputer 12 would change the display locations of the respective AF frames and the zoom powers of the spaces between the AF frames according to the zoom power entered by the user.

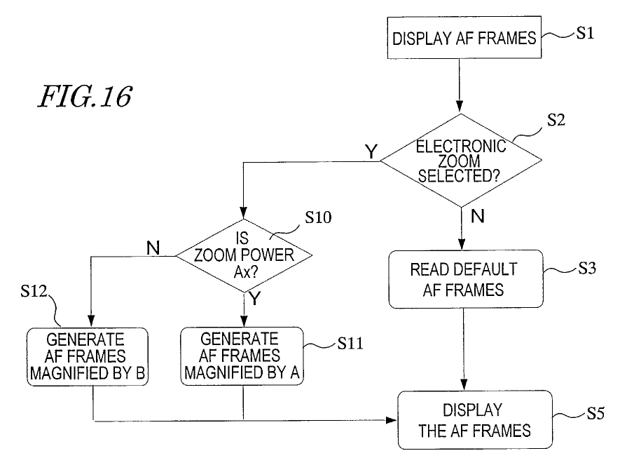

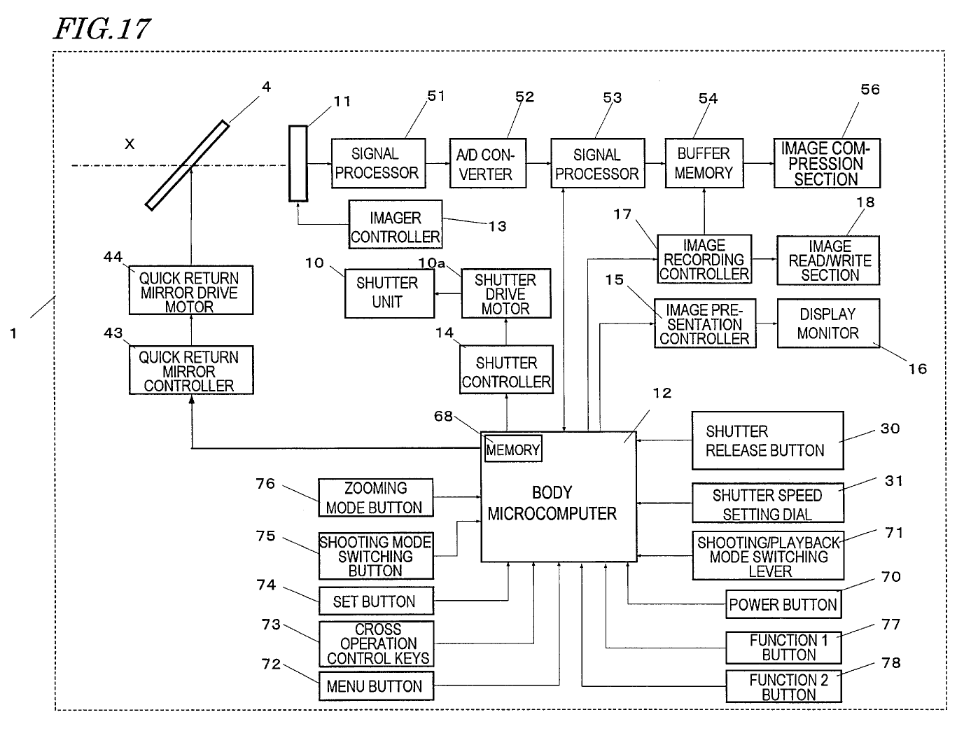

Hereinafter, it will be described with reference to FIGS. 15 and 16 exactly how the digital camera of this preferred embodiment carries out the AF frame display process.

FIG. 15 is a flowchart showing a first exemplary procedure of AF frame display processing to be carried out by the digital camera. It should be noted that by default (i.e., if no electronic zoom has been selected), the sizes of the AF frames to be displayed on the display monitor 16 and the space between the frames are determined by the data that is stored in advance in the memory to be described later.

First, in Step S1, the body microcomputer 12 displays the respective AF frames on the display monitor 16 by default. Next, in Step S2, the body microcomputer 12 determines whether or not any electronic zoom mode has been selected. If no electronic zoom mode has been selected (i.e., if the zoom power specified is 1.0×), the process advances to Step S3. Otherwise, the process advances to Step S4.

In Step S3, the body microcomputer 12 continues to read the default AF frames from the memory to be described later. Next, in Step S5, the body microcomputer 12 displays those AF frames.

On the other hand, in Step S4, the body microcomputer 12 senses the user's specified zoom power. Suppose the zoom power is N (where N>1), for example. Thereafter, the body microcomputer 12 generates AF frames, of which the display locations and sizes have been multiplied by the factor of N, in Step S6 and then displays those AF frames on the display monitor 16 in Step S5.

For example, if an electronic zoom power of 2× has been specified, the body microcomputer 12 doubles the sizes of the respective AF frames and the space between the AF frames by performing the processing steps S4 and S6. As a result, the respective AF frames are displayed at the locations and in the sizes corresponding to the zoom power as shown in FIG. 14. Consequently, there is no deviation between the actual positions of the AF sensors and the locations of the objects images on the display monitor 16 and the focus can be found just as intended by the user.

FIG. 16 is a flowchart showing a second exemplary procedure of AF frame display processing to be carried out by the digital camera. This processing is carried out in an electronic zoom mode in which the number of recording pixels is set stepwise. As used herein, “to set the number of recording pixels stepwise” means that the digital camera has electronic zoom modes with Ax and Bx zoom powers. The processing steps S1, S2 and S3 are the same as those already described with reference to FIG. 15 and the description thereof will be omitted herein.

In Step S10, the body microcomputer 12 determines whether or not the electronic zoom power is Ax. If the answer is YES, the process advances to Step S11. Otherwise, the process advances to Step S12.

In Step S11, the body microcomputer 12 generates AF frames that have been magnified by the power of Ax. On the other hand, in Step S12, the electronic zoom power is regarded as Bx, which is the other option, and AF frames that have been magnified by the power of Bx are generated.

By performing the processing step S11 or S12, respective AF frames are displayed in Step S5 at the locations and in the sizes corresponding to the zoom power. Consequently, there is no deviation between the actual positions of the AF sensors and the locations of the objects images on the display monitor 16 and the focus can be found just as intended by the user.

In FIGS. 15 and 16, in generating AF frames according to the zoom power, the calculations may be done as needed according to the electronic zoom power detected. Alternatively, multiple sets of display data of the respective AF frames that have been magnified according to the electronic zoom power may be stored in advance in a memory. Still alternatively, reference AF frame images may be stored in a memory, and a table describing display locations and magnifications that are associated with respective electronic zoom powers may be stored in a memory inside or outside of the body microcomputer 12. The following Table 1 shows one such example:

TABLE 1

| Electronic zoom power | Display location | Magnification |
|---|---|---|
| 1x | (X1, Y1) | 1 |
| 2x | (X2, Y2) | 2 |
| 4x | (X3, Y3) | 4 |

The body microcomputer 12 may make reference to the memory with the magnification or reduction rate of the image, read the display location data and magnification data required, and then display the AF frames on the display monitor 16.

The example described above is the process of magnifying AF frames. However, even if an image that has been zoomed in by the electronic zoom processing should be zoomed out, the body microcomputer 12 may also reduce respective AF frames at the locations and to the sizes that are associated with the zoom power and display those AF frames on the display monitor 16.

In FIG. 11 and other drawings, three AF frames are displayed. However, any other number of AF frames may be displayed. That is to say, the number of AF frames may be greater than, or less than, three. Also, the shapes of those AF frames are just examples, and therefore, any other shape may be adopted as well.

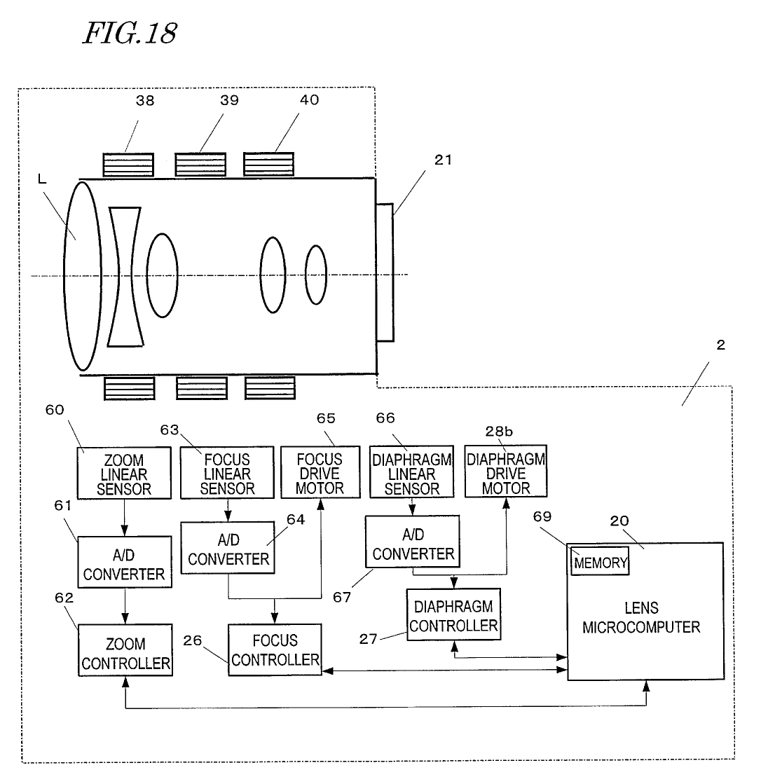

Hereinafter, the hardware configurations of the camera body 1 and the imaging lens device 2 of this preferred embodiment will be described in detail with reference to FIGS. 17 and 18.

FIG. 17 is a block diagram showing a control system for the camera body 1 of this preferred embodiment.

The body microcomputer 12 can receives signals from the shutter release button 30, the shutter speed setting dial 31, the shooting/playback mode switching lever 71, the MENU button 72, the cross operation control keys 73, the SET button 74, the shooting mode switching button 75, the zooming mode button 76, the Function #1 button 77 and the Function #2 button 78. Also, the body microcomputer 12 can transmit signals to a shutter controller 14 and a quick return mirror controller 43. Furthermore, the body microcomputer 12 can exchange signals with an image recording controller 17, an image presentation controller 15 and a signal processor 53. The body microcomputer 12 further includes a memory 68 to store those signals.

The shutter controller 14 drives a shutter drive motor 10a (not shown) in response to a control signal supplied from the body microcomputer 12. The quick return mirror controller 43 drives a quick return mirror drive motor 44 in response to a control signal supplied from the body microcomputer 12.

The shutter release button 30 notifies the body microcomputer 12 of the shutter timing. The shutter speed setting dial 31 transmits information about the shutter speed and shutter mode that have been selected.

The imagers 11 may be CCDs (charge coupled devices), for example, and convert an optical image, which has been produced by the imaging optical system L of the imaging lens device 2, into an electrical image signal. The imagers 11 are driven and controlled by an imager controller 13. The output image signals of the imagers 11 are processed by a signal processor 51, an A/D converter 52, the signal processor 53, a buffer memory 54 and an image compression section 56 in this order.

The image signals are transmitted from the imagers 11 to the signal processor 51, which subjects the output image signals of the imagers 11 to signal processing such as gamma correction. Then, the image signals are passed from the signal processor 51 to the A/D converter 52, which convert the analog image signals supplied from the signal processor 51 into digital signals.

Thereafter, the image signals are transmitted from the A/D converter 52 to the signal processor 53, which subjects the image signals, converted into digital signals by the A/D converter 52, to various types of signal processing including noise reduction and contour enhancement. The signal processor 53 can also subject the image signals to electronic zoom processing. Subsequently, the image signals are sent from the signal processor 53 to the buffer memory 54, which temporarily stores the image signals that have been processed by the signal processor 53. The buffer memory 54 may be a RAM (random access memory), for example. Alternatively, the signal processor 53 may also output, as image data to be displayed, non-electronic-zoomed image data, electronic-zoomed image data or image data generated by subjecting the electronic-zoomed or non-electronic-zoomed image data to a predetermined type of processing.

In accordance with an instruction given by the image recording controller 17, the image signals are transmitted from the buffer memory 54 to the image compression section 56, which compresses the data of the image signals to a predetermined size following the instruction issued by the image recording controller 17. The data of the image signals is compressed at a predetermined rate to a smaller size than the original one. This compression may be carried out compliant with the JPEG (Joint Photographic Experts Group) standard, for example.

The compressed image signals are transmitted from the image compression section 56 to an image read/write section 18. Meanwhile, the body microcomputer 12 sends control signals to the image recording controller 17 and the image presentation controller 15. The image recording controller 17 controls the image read/write section 18 in accordance with the control signal supplied from the body microcomputer 12. The image presentation controller 15 controls the display monitor 16 in accordance with the control signal supplied from the body microcomputer 12.

Following the instruction given by the image recording controller 17, the image read/write section 18 writes the image signals on an internal memory and/or a removable memory. Also, in accordance with the instruction given by the image recording controller 17, the image read/write section 18 writes additional information, which should be stored along with the image signals, in the internal memory and/or the removable memory. Examples of the additional information to be stored along with the image signals include image shooting date and time, focal length information, shutter speed information, diaphragm value information and shooting mode information.

In accordance with the instruction given by the image presentation controller 15, the display monitor 16 displays the image signals as a visible image. Also, following the instruction given by the image presentation controller 15, the display monitor 16 displays additional information to be presented along with the image signals. At this point in time, AF frame information is also displayed on the display monitor 16 in accordance with the instruction given by the image presentation controller 15. Examples of the additional information to be displayed along with the image signals include focal length information, shutter speed information, diaphragm value information, shooting mode information, focusing state information, and various pieces of information about the imaging lens device 2 such as the presence or absence of a diaphragm ring 40, the step to set the diaphragm value and the step width.

Also, following the instruction given by the image presentation controller 15, the display monitor 16 displays a setting menu image on which the shooter or something should make settings in a predetermined shooting or playback mode.

To take a shot, the shooter or something turns the power button 70 ON and adjusts the shooting/playback mode switching lever 71 to shooting mode. As a result, the power of the camera body 1 is turned ON, and the object image, which has been converted into an electrical image signal by the imagers 11, is presented as a visible image on the display monitor 16 in accordance with the instruction given by the image presentation controller 15.

If the shooter or something presses the MENU button 72 while the camera body 1 is in the shooting mode, a setting menu image, showing setting items that can be changed by the shooter or something in the shooting mode, is presented on the display monitor 16 in accordance with the instruction given by the image presentation controller 15.

FIG. 18 is a block diagram showing a control system for the imaging lens device 2 according to this preferred embodiment.

The lens microcomputer 20 can exchange signals with a zooming controller 62, a focusing controller 26 and a diaphragm controller 27.

The zooming controller 62 may receive a signal from a zoom linear sensor 60 by way of an A/D converter 61. The zooming controller 62 transforms the angle of rotation of the zoom ring 38, which has been detected by the zoom linear sensor 60, into focal length information for the imaging optical system L. The zooming controller 62 transmits the focal length information to the lens microcomputer 20.

The focusing controller 26 may receive a signal from a focus linear sensor 63 by way of an A/D converter 64 and may transmit a signal to a focus drive motor 65. The focusing controller 26 determines the focusing mode by the angle of rotation of the focus ring 39 that has been detected by the focus linear sensor 63 and then converted into a digital signal by the A/D converter 64. Then the focusing controller 26 notifies the lens microcomputer 20 of the focusing mode determined. Also, in accordance with the instruction given by the lens microcomputer 20, the focusing controller 26 transmits object's distance information that has been detected based on the angle of rotation of the focus ring 39 to the lens microcomputer 20. Furthermore, in response to the control signal supplied from the lens microcomputer 20, the focusing controller 26 drives the focus drive motor 65.

The diaphragm controller 27 may receive a signal from a diaphragm linear sensor 66 by way of an A/D converter 67 and may transmit a signal to a diaphragm drive motor 28b. The diaphragm controller 27 determines the diaphragm mode by the angle of rotation of the diaphragm ring 40 that has been detected by the diaphragm linear sensor 66 and then converted into a digital signal by the A/D converter 67. Then the diaphragm controller 27 notifies the lens microcomputer 20 of the diaphragm mode determined. Also, in accordance with the instruction given by the lens microcomputer 20, the diaphragm controller 27 transmits diaphragm value information that has been detected based on the angle of rotation of the diaphragm ring 40 to the lens microcomputer 20. Furthermore, in response to the control signal supplied from the lens microcomputer 20, the diaphragm controller 27 drives the diaphragm drive motor 28b.

In a memory section 69 in the lens microcomputer 20, stored are various programs for the imaging lens device 2, data showing correlation between the focal length or the distance to the object and the magnitude of shift of a group of focus lenses 25, information about whether or not the diaphragm ring 40 is included, and data about the diaphragm value setting step and the step width.

Hereinafter, it will be described how the camera body 1 carries out a shooting operation. As described above, the image capture device of this preferred embodiment has two shooting modes.

First, a drive sequence to be followed in the standard shooting mode in which the shooter or something takes a shot of an object by looking through the viewfinder ocular window 9 will be described with reference to FIG. 2.

When the shooter or something presses the shutter release button 30 halfway, power is supplied to the body microcomputer 12 and various units in the camera body 1. The body microcomputer 12 to be activated in the camera body 1 when supplied with power receives various sorts of lens data from the lens microcomputer 20, which is also activated in the imaging lens device 2 when supplied with power, by way of the lens mount 21 and the body mount 23, and then stores the lens data in its internal memory 68. Next, the body microcomputer 12 acquires the magnitude of defocus (which will be referred to herein as “Df magnitude”) from the focus detecting unit 5 and instructs the lens microcomputer 20 to drive the group of focus lenses 25 by the Df magnitude. The lens microcomputer 20 controls the focusing controller 26, thereby shifting the group of focus lenses 25 by the Df magnitude. As the focus detection and drive of the group of focus lenses 25 are repeated a number of times, the Df magnitude will decrease gradually. And when the Df magnitude becomes equal to or smaller than a predetermined value, it is determined that the focus has been found and the group of focus lenses 25 stops being driven.

Thereafter, the body microcomputer 12 instructs the lens microcomputer 20 to control the diaphragm value to the value that has been calculated based on the output of a photometric sensor (not shown) by performing the operation of pressing the shutter release button 30 down all the way. In response, the lens microcomputer 20 controls the diaphragm controller 27 such that the diaphragm value is reduced to the specified one. As soon as the diaphragm value is specified, the body microcomputer 12 gets the quick return mirror 4 retracted from the optical path X by the quick return mirror controller 43. After the mirror 4 has been retracted, the imager controller 13 instructs that the imagers 11 start to be driven and that the shutter unit 10 be activated. It should be noted that the imager controller 13 exposes the imagers 11 to incoming light for only a period of time corresponding to the shutter speed that has been calculated based on the output of the photometric sensor (not shown).

When the exposure is completed, the imager controller 13 reads image signals from the imagers 11 and controls the imagers such that the captured images are presented on the display monitor 16 after predetermined image processing. Or the imager controller 13 may instruct the image read/write section 18 to write the image signals on a storage medium. Also, when the exposure is finished, the quick return mirror 4 and the shutter unit 10 are returned to their initial positions. The body microcomputer 12 instructs the lens microcomputer 20 to reset the diaphragm into an open position and the lens microcomputer 20 issues a reset instruction for respective units. And when the reset is complete, the lens microcomputer 20 notifies the body microcomputer 12 of the fact. The body microcomputer 12 waits until the reset complete information is provided by the lens microcomputer 20 and until a series of processing is done after the exposure process. After that, the body microcomputer 12 sees if the shutter release button 30 is not pressed down to end the shooting sequence.

Next, a drive sequence to be carried out in the live view mode, in which the shooter or something takes a shot of an object using the display monitor 16, will be described with reference to FIG. 3.

In taking a shot using the display monitor 16, the shooting mode switching button 75 is pressed to change the modes into the live view mode. When the live view mode is entered, the body microcomputer 12 retracts the quick return mirror 4 from the optical path X. As a result, the object image reaches the imagers 11. Then, the imager controller 13 reads image signals from the imagers 11, subjects them to a predetermined type of image processing, and then displays the captured image on the display monitor 16. In this case, the predetermined type of image processing includes processing of setting an imaging range if the first and/or second type(s) of electronic zoom are/is activated. By presenting the captured image on the display monitor 16 in this manner, the shooter or something can follow his or her object without looking through the viewfinder ocular window 9. In this case, AF frames are displayed on the display monitor 16, and the shooter can find a focus on his or her desired objects within the captured image by superimposing the AF frames on the objects to be focused. Also, since AF frames of predetermined sizes are displayed as described above even when the electronic zoom is ON, there is no deviation between the positions of the AF sensors and the display locations of the AF frames, and the focus can be found just as intended.

Next, when the shooter or something presses the shutter release button 30 halfway, the body microcomputer 12 in the camera body 1 receives various sorts of lens data from the lens microcomputer 20 in the imaging lens device 2 by way of the lens mount 21 and the body mount 23, and then stores the lens data in its internal memory. Next, the body microcomputer 12 gets the quick return mirror 4 returned to its predetermined position on the optical path X by the quick return mirror controller 43, acquires the Df magnitude from the focus detecting unit 5 and instructs the lens microcomputer 20 to drive the group of focus lenses 25 by the Df magnitude. The lens microcomputer 20 controls the focusing controller 26, thereby shifting the group of focus lenses 25 by the Df magnitude. As the focus detection and drive of the group of focus lenses 25 are repeated a number of times, the Df magnitude will decrease gradually. And when the Df magnitude becomes equal to or smaller than a predetermined value, it is determined that the focus has been found and the group of focus lenses 25 stops being driven. At this point in time, the quick return mirror 4 has been returned to its predetermined position on the optical path X, and therefore, the object image does not reach the imagers 11. In that case, the display monitor 16 would normally be solid black, which would make the shooter feel uneasy, though. That is why instead of turning the display monitor 16 into solid black, the image that had been presented on the display monitor 16 until just before the shutter release button 30 was pressed halfway is presented again as a still picture. Then, the shooter can continue the shooting operation without feeling uneasy. Also, since the image presented at this time is different from the image presented in real time during framing, a message like “AF operation is ON” may be posted on the display monitor 16 to make the shooter notice that. This AF operation is usually done in just a short time after the shooter has finished the framing operation. That is why even if such a message were posted, no big problem should arise and the shooter would be able to continue his or her shooting operation without worrying about the absence of the image captured so much.

Thereafter, the body microcomputer 12 instructs the lens microcomputer 20 to control the diaphragm value to the value that has been calculated based on the output of a photometric sensor (not shown) by performing the operation of pressing the shutter release button 30 down all the way. In response, the lens microcomputer 20 controls the diaphragm controller 27 such that the diaphragm value is reduced to the specified one. As soon as the diaphragm value is specified, the body microcomputer 12 gets the quick return mirror 4 retracted from the optical path X by the quick return mirror controller 43. After the mirror 4 has been retracted, the imager controller 13 instructs that the imagers 11 start to be driven and that the shutter unit 10 be activated. It should be noted that the imager controller 13 exposes the imagers 11 to incoming light for only a period of time corresponding to the shutter speed that has been calculated based on the output of the photometric sensor (not shown).

When the exposure is completed, the imager controller 13 reads image signals from the imagers 11 and controls the imagers such that the captured images are presented on the display monitor 16 after predetermined image processing. Or the imager controller 13 may instruct the image read/write section 18 to write the image signals on a storage medium. Alternatively, even after the exposure is finished, the quick return mirror 4 may still be kept retracted from the optical path X to continue the live view mode.

On the other hand, to end the live view mode, the shooting mode switching button 75 may be pressed to change the shooting modes into the standard shooting mode, in which the shooter is supposed to take a shot of an object by looking through the viewfinder ocular window 9. In that case, the quick return mirror 4 is returned to its predetermined position on the optical path X. Furthermore, in turning OFF the power of the camera body 1, the quick return mirror 4 is also returned to its predetermined position on the optical path X.

As described above, by introducing the live view mode into this digital camera, even the user of this digital camera can take a shot using the display monitor instead of looking through the viewfinder. That is why this digital camera is very easy to use especially for beginners who are not used to handling such digital cameras. In addition, by displaying AF frames of appropriate sizes even when the electronic zoom is ON, there should be no deviation between the display locations of the AF frames and the positions of their associated AF sensors and the focus can be found just as intended. On top of that, by getting an image presented continuously on the display monitor 16 even while the AF operation is ON during the live view mode, the shooter can take a shot without feeling uneasy at all.

In the preferred embodiments described above, the imaging lens device is supposed to have a zooming lens system. However, an imaging lens device including a single focus lens system with no optical zoom function may also be attached. Even so, the first electronic zoom mode is also a mode in which the zoom power is determined by the number of recording pixels and the second electronic mode is also a mode in which the zoom power itself is accepted. As for the sizes of the AF frames displayed, the sizes are determined by the selected number of recording pixels in the first electronic zoom mode but are determined by the selected zoom power in the second electronic zoom mode. As a result, the focus can always be found just as intended.

The present invention is effectively applicable to digital still cameras and digital camcorders and can be used particularly effectively in single lens reflex digital still cameras.

What is claimed is:

1. An image capture device to be connected to an imaging lens device such that the imaging lens device is attachable to, and removable from, the image capture device, the imaging lens device including an imaging lens system that produces an image of an object, the image capture device comprising:
a movable mirror, which is entered into, and removed from, an optical path, thereby changing positions where the object image is produced between first and second positions;
an imager, which is arranged at the first position to shoot the object image and generate an image signal;
a signal processor for performing zoom-in or zoom-out processing on the image in accordance with the image signal and thereby generating a processed image signal;
a focus sensor for sensing a focusing signal, representing a focusing state of a part of the object image, based on the object image being produced at the second position;
a display device for presenting the image based on the image signal; and
a controller for controlling the generation of a focus frame to be further displayed on the display device,
wherein the focus frame is displayed at a location on the image that is associated with the part of the object image to indicate a position where the focus sensor is supposed to detect the focusing state, and
wherein the controller changes display of the focus frame according to whether or not the zoom-in or zoom-out processing is performed by the signal processor on the image and displays the focus frame on the display device.

2. The image capture device of claim 1, wherein the controller changes the sizes of the focus frame according to the zoom-in or zoom-out power of the image performed by the signal processor and displays the focus frame on the display device.

3. The image capture device of claim 2, wherein there are a number of focus frames, and
wherein the controller changes distances between the focus frames according to the zoom-in or zoom-out power of the image performed by the signal processor and displays the focus frames on the display device.

4. The image capture device of claim 2, wherein the controller includes a memory for storing data items representing a plurality of display modes of the focus frame that are associated with the zoom-in and zoom-out powers of the image to be performed by the signal processor, and
wherein according to the zoom-in or zoom-out power of the image performed by the signal processor, the controller makes reference to the memory, reads one of the data items representing the display modes, changes the sizes of the focus frame in accordance with the read data, and then displays the frame on the display device.

5. The image capture device of claim 4, wherein the memory stores data items representing a plurality of display modes, in which the focus frame has mutually different display locations and magnifications, in association with the zoom-in and zoom-out powers of the image to be performed by the signal processor.
